(19) United States
(12) Patent Application Publication
(10) Pub. No.: US 2014/0321551 A1
(43) Pub. Date: Oct. 30, 2014

(54) WEIGHTED PREDICTIONS BASED ON MOTION INFORMATION

(71) Applicant: DOLBY LABORATORIES LICENSING CORPORATION, San Francisco, CA (US)

(72) Inventors: Yan Ye, San Diego, CA (US); Alexandros Tourapis, Milpitas, CA (US)

(73) Assignee: DOLBY LABORATORIES LICENSING CORPORATION, San Francisco, CA (US)

(21) Appl. No.: 14/351,496

(22) PCT Filed: Oct. 18, 2012
(86) PCT No.: PCT/US2012/060826

§ 371 Date: Apr. 11, 2014

Related U.S. Application Data
(60) Provisional application No. 61/550,267, filed on Oct. 21, 2011.

(51) Int. Cl. H04N 19/51

(52) U.S. Cl. CPC H04N 19/00587
USPC 375/240.16

(57) ABSTRACT

Weighted predictions may be used in a video encoder or decoder to improve the quality of motion predictions. Systems and methods of video processing with weighted predictions based on motion information are discussed. Specifically, systems and methods of video processing with iterated and refined weighted predictions based on motion information are shown.

### CROSS REFERENCE TO RELATED APPLICATIONS

This application claims the benefit of U.S. Provisional Application No. 61/550,267, filed on Oct. 21, 2011, which is hereby incorporated by reference in its entirety. The present application is related to U.S. Provisional Application No. 61/550,280, filed on Oct. 21, 2011, which is hereby incorporated by reference in its entirety.

### FIELD

The disclosure relates generally to video processing. More specifically, it relates to video processing with weighted predictions based on motion information.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 shows a block diagram of an exemplary block-based video coding system.

FIG. 2 shows a block diagram of an exemplary block-based video decoding system.

FIG. 3 is a diagram showing an example of block-based motion prediction with a motion vector for motion compensation based temporal prediction.

FIG. 4 is a flow chart showing an exemplary multiple-pass encoding method in an embodiment of the present disclosure.

FIG. 5 is a diagram showing an example of a picture using bi-prediction of parts of the picture and single list prediction in other parts of the picture.

FIG. 6 is a diagram showing an example of a hierarchical motion estimation engine framework for performing a layered motion search on multiple down-sampled hierarchical layers (h-layers) of an input video.

FIG. 7 is a diagram showing another example of the down-sampled h-layers of the input video for hierarchical motion estimation.

FIG. 8 is a flow chart showing an exemplary iterative method for motion search and weighted prediction parameter estimation.

### DESCRIPTION OF EXAMPLE EMBODIMENTS

According to a first aspect of the disclosure, a method for generating prediction pictures adapted for use in performing compression of video signals is disclosed. The method comprises: a) providing an input video signal, the input video signal comprising input blocks, regions, slices, layers or pictures; b) performing a first coding pass, the first coding pass comprising a first motion estimation, wherein the first motion estimation is based on one or more reference pictures and the input blocks, regions, slices, layers or pictures in the input video signal; c) deriving a first set of weighted prediction parameters based on results of the first coding pass; d) calculating a second motion estimation based on results of the first motion estimation and the first set of weighted prediction parameters; e) producing a second set of weighted prediction parameters based on the first set of weighted prediction parameters and results of the second motion estimation; f) evaluating a convergence criterion to see if a set value is reached; and g) iterating steps d) through f) to produce a third and subsequent motion estimations and a third and subsequent sets of weighted prediction parameters if the set convergence criterion has not been reached, until the set convergence criterion is reached or a set number of iterations are performed, thus generating prediction pictures for the performing compression of video signals.

According to a second aspect of the disclosure, a method for encoding an input video into a bitstream, the input video comprising image data and input pictures, is disclosed. The method comprises: a) performing at least one of spatial prediction and motion prediction based on reference pictures from a reference picture buffer and the image data of the input video and performing mode selection and encoder control logic based on the image data to provide a plurality of prediction pictures; b) taking a difference between the input pictures of the input video and pictures in the plurality of prediction pictures to obtain residual information; c) performing transformation and quantization on the residual information to obtain processed residual information; and d) performing entropy encoding on the processed residual information to generate the bitstream.

According to a third aspect of the disclosure, an encoder adapted to receive an input video and output a bitstream, the input video comprising image data, is disclosed. The encoder comprises: a) a mode selection unit, wherein the mode selection unit is configured to determine mode selections and other control logic based on input pictures of the input video and the mode selection unit is configured to generate prediction pictures from spatial prediction pictures and motion prediction pictures; b) a spatial prediction unit connected with the mode selection unit, wherein the spatial prediction unit is configured to generate the spatial prediction pictures based on reconstructed pictures and the input pictures of the input video; c) a motion prediction unit connected with the mode selection unit, wherein the motion prediction unit is configured to generate the motion prediction pictures based on reference pictures from a reference picture buffer and input pictures of the input video; d) a first adder unit connected with the mode selection unit, wherein the first adder unit is configured to take a difference between the input pictures of the input video and the prediction pictures to provide residual information; e) a transforming unit connected with the first adder unit, wherein the transforming unit is configured to transform the residual information to obtain transformed information; f) a quantizing unit connected with the transforming unit, wherein the quantizing unit is configured to quantize the transformed information to obtain quantized information; and g) an entropy encoding unit connected with the quantizing unit and the mode selection unit, wherein the entropy encoding unit is configured to generate the bitstream from the quantized information and is configured to encode mode information from the mode selection unit.

Methods and systems for decoding bitstreams encoded in accordance with the various aspects of the disclosure are also disclosed.

Video coding systems are used to compress digital video signals and may be useful to reduce the storage need and/or transmission bandwidth of such signals. There are many types of video coding systems, including but not limited to block-based, wavelet-based, region-based, and object-based systems. Among these, block-based systems are currently widely used and deployed. Examples of block-based video coding systems include international video coding standards such as the MPEG-1/2/4, H.264/MPEG-4 AVC [reference 1, incorporated herein by reference in its entirety] and VC-1 [reference 2, incorporated herein by reference in its entirety] standards. This disclosure will frequently refer to block-based video coding systems as an example in explaining the embodiments of the disclosure. However, the block-based descriptions may be applicable to any of blocks, regions, slices, layers or pictures of a video signal for video processing.

A person skilled in the art of video coding will understand that the embodiments addressed herein can be applied to any type of video coding system that utilizes motion compensation and weighted prediction to reduce and/or remove temporal redundancy inherent in video signals. Hence, the block-based video coding system, while referred to, should be taken as an example and should not limit the scope of this disclosure. Consequently, for clarity purposes, the terms “pictures” and “blocks” are used in the present disclosure to refer generally to any of blocks, regions, slices, layers or pictures.

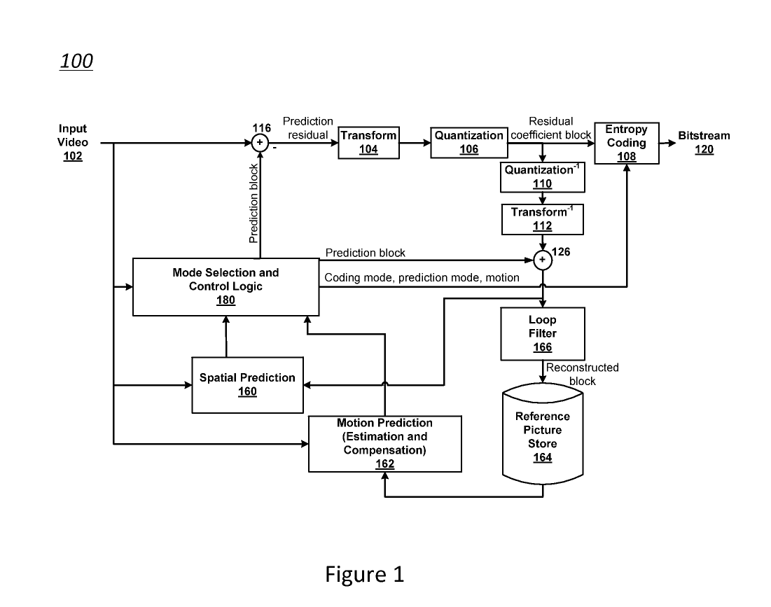

FIG. 1 shows a block diagram of an exemplary block-based video coding system (100). An input video signal (102) is processed block by block. A commonly used video block unit consists of 16×16 pixels (also commonly referred to as a “macroblock”). For each input video block, spatial prediction (160) and/or temporal prediction (162) may be performed as selected by a mode selection and control logic (180). Selection between spatial prediction (160) and/or temporal prediction (162) by the mode selection and control logic (180) may be based, for instance, on rate-distortion evaluation.

Spatial prediction (160) utilizes already coded neighboring blocks in the same video picture/slice to predict a current video block. Spatial prediction (160) can exploit spatial correlation and remove spatial redundancy inherent in the video signal. Spatial prediction (160) is also commonly referred to as “intra prediction.” Spatial prediction (160) may be performed on video blocks or regions of various sizes and shapes, although block based prediction is common. For example, H.264/AVC in its most common, consumer oriented profiles allows block sizes of 4×4, 8×8, and 16×16 pixels for spatial prediction of the luma component of the video signal and allows a block size of 8×8 pixels for the chroma components of the video signal.

The term “luma” is defined herein as a weighted sum of gamma-compressed R′G′B′ components of color video, where the prime symbols (′) denote gamma-compression. The term “chroma” is defined herein as a signal, separate from an accompanying luma signal, used in video systems to convey color information of a picture.

Temporal prediction (162) utilizes video blocks from neighboring video frames from reference pictures stored in a reference picture store or buffer (164) to predict the current video block and thus can exploit temporal correlation and remove temporal redundancy inherent in the video signal. Temporal prediction (162) is also commonly referred to as “inter prediction,” which includes “motion prediction.” Like spatial prediction (160), temporal prediction (162) also may be performed on video blocks of various sizes. For example, for the luma component, H.264/AVC allows inter prediction block sizes such as 16×16, 16×8, 8×16, 8×8, 8×4, 4×8, and 4×4.

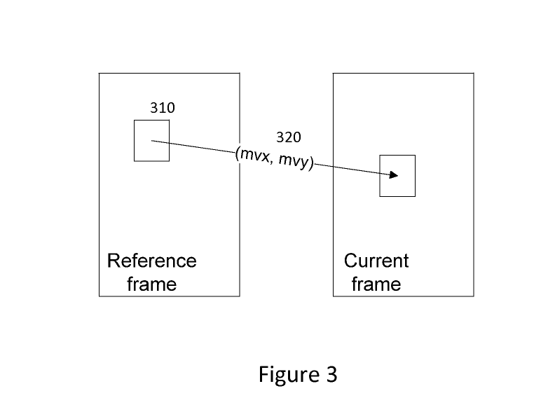

FIG. 3 shows an example of block-based (310) motion prediction with a motion vector (320) (mvx, mvy). Further, one can use multi-hypothesis temporal prediction for performing motion prediction, where a prediction signal is generated by combining a number of prediction signals from different reference pictures. One example is bi-prediction, supported by many video coding standards, including MPEG2, MPEG4, H.264/AVC, and VC-1. Bi-prediction combines two prediction signals, each from a reference picture, to form a prediction such as the following:

P(x,y)=(P₀(x,y)+P₁(x,y)+1)>>1 (1)

With reference back to FIG. 1, individual predictions from the spatial prediction (160) and/or the motion prediction (162) can go through mode selection and control logic (180), from which a prediction block is generated. For example, the mode selection and control logic (180) can be a switch that switches between spatial prediction (160) and motion prediction (180) based on image information or rate-distortion evaluation.

After prediction, the prediction block can be subtracted from an original video block at a first adder unit (116) to form a prediction residual block. The prediction residual block is transformed at transforming unit (104) and quantized at quantizating unit (106). The quantized and transformed residual coefficient blocks are then sent to an entropy coding unit (108) to be entropy coded to further reduce bit rate. The entropy coded residual coefficients are then packed to form part of an output video bitstream (120).

The quantized and transformed residual coefficient blocks can be inverse quantized at inverse quantizing unit (110) and inverse transformed at inverse transforming unit (112) to obtain a reconstructed residual block. A reconstructed video block can be formed by adding the reconstructed residual block to the prediction video block at a second adder unit (126). The reconstructed video block may be sent to the spatial prediction unit (160) for performing spatial prediction. Before being stored in a reference picture store (164), the reconstructed video block may also go through additional filtering at loop filter unit (166) (e.g., in-loop deblocking filter as in H.264/AVC). The reference picture store (164) can be used for coding of future video blocks in the same video picture/slice and/or in future video pictures/slices. Reference data in the reference picture store (164) may be sent to the temporal prediction unit (162) for performing temporal prediction.

Along the temporal dimension, video signals may contain illumination changes such as fade-in, fade-out, cross-fade, dissolve, flashes, and so on. Such illumination changes may happen locally (within a region of a picture) or globally (over an entire picture). In order to improve accuracy of motion prediction for regions with illumination change, some video coding systems (e.g., H.264/AVC) allow weighted prediction, such as a linear weighted prediction expressed in the following form,

WP(x,y)=w·P(x,y)+o (2)

where P(x, y) and WP(x, y) are prediction values for pixel location (x, y) before and after weighted prediction, respectively, and w and o are the weight and offset used in the weighted prediction. The motion predicted value of P(x, y) can be written as follows:

P(x,y)=R(x−mvx,y−mvy) (3)

where R(x, y) is the value at pixel location (x, y) in the reference picture and (mvx,mvy) is the corresponding motion vector (320) of FIG. 3.

For the bi-predictive case (where the prediction signal is formed by combining two prediction signals from two different reference pictures, for example, in the form of equation (1)), a linear weighted prediction may be expressed in the following form,

WP(x,y)=(w⁰·P⁰(x,y)+o⁰+w¹·P¹(x,y)+o¹+1)>>1 (4)

where P⁰(x,y) and P¹(x,y) are the prediction signals for the pixel location (x, y) from each reference picture in each prediction list (e.g., LIST_{—}0 and LIST_{—}1) before weighted prediction; WP(x, y) is the bi-predictive signal after weighted prediction; and w⁰, o⁰, w¹, and o¹ are the weights and offsets for the reference pictures in each prediction list.

In video coding systems such as H.264/AVC, for P-coded pictures/slices, explicit weighted prediction can be used, where the weights and the offsets are decided by the encoder and signaled to the decoder. For B-coded pictures/slices, besides explicit weighted prediction, H.264/AVC also supports implicit weighted prediction, where the weights are derived based on relative picture coding order distance between the current picture and both of its reference pictures while the offsets are set to 0 (o₀=o₁=0). Because the decoder can also derive the implicit weights in the same way as the encoder, there may be no explicit need to send these implicit weighted prediction parameters in the video bitstream (such as 120 in FIG. 1).

Embodiments of the present disclosure are directed to a process of finding optimal values for the weights and offsets for explicit weighted prediction. Various methods to obtain accurate weighted prediction parameters, such as the weights and offsets as in equations (2) and (4), will be discussed in detail.

Weighted prediction can significantly improve quality of motion prediction in the case of illumination change, hence reducing the energy of the prediction residual block coming out of the first adder unit (116). Consequently, coding performance can be improved in the form of one or both of bit rate reduction and quality improvement of reconstructed video. Obtaining accurate weight and offset parameters w and o is an aspect of benefiting from weighted prediction and motion prediction in general. Previously, many algorithms for deriving the weighted prediction parameters are introduced, including those in the H.264/AVC JM reference software [reference 2]. These algorithms analyze image characteristics of an input video signal such as average DC values, variance values, color histograms, and so on. The weight and offset parameters w and o are then derived by finding a relationship between the values of these image characteristics in the current picture and its reference picture or pictures. For example, a simple weight-only or a simple offset-only calculation may be used, such as in equations (5) and (6), respectively.

w=DC(current)/DC(reference) (5)

o=DC(current)−DC(reference) (6)

where DC(current) and DC(reference) are the DC values of the current frame and the reference picture, respectively. Other more sophisticated algorithms, such as the Least Mean Squared (LMS) algorithm, may also be used [reference 2] [reference 6, incorporated by reference in its entirety]. Characteristics of image-analysis based weighted prediction (WP) parameter derivation processes include the following:
1. They can rely on only image characteristics of the current frame and the reference picture without relying on motion relationship between the current frame and the reference picture. Therefore, the WP parameters can be obtained before motion estimation of the current picture/slice is performed.
2. Values of the image characteristics can be pre-computed and stored together with the reconstructed video frames in the reference picture store (164), making the derivation process very fast and of low complexity.

Motion estimation and motion compensation may also be performed before WP parameter calculation to improve performance [references 5 and 7-10, each of which is incorporated by reference in its entirety]. For example, rather than using the reference picture directly as in equations (5) and (6), a prediction signal based on motion information (such as given in equation (3)) may be used instead. Various considerations for deriving accurate WP parameters based on motion information will be explained in further detail in Sections 1 to 5 of the present disclosure. Especially, an iterative method may be utilized to improve the accuracy of motion and WP parameters by following these steps:
1. Perform motion estimation and use the motion information to derive WP parameters,
2. Use derived WP parameter to refine the motion estimation, and use the refined motion information to further refine WP parameters, and
3. Iterate steps 1 and 2 until convergence or until a set number of iterations are performed.

Some encoders may perform pre-analysis on the input video to facilitate efficient coding. In particular, an encoder may segment the image into several regions, with each region possessing certain common features (for example, uniform illumination change within each region). These regions may then be coded separately based on their distinct characteristics. For example, the WP parameters may be derived and conveyed for each region separately. In this case, the image analysis based methods mentioned above (e.g., equations (5) and (6)), or the motion compensation based process detailed below, will be applied on each individual region instead of on the entire picture.

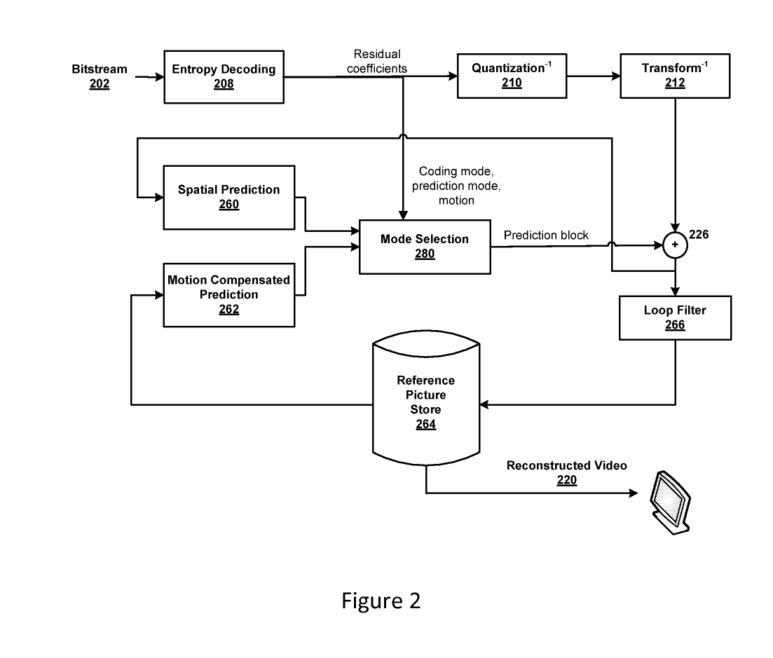

FIG. 2 shows a diagram of an exemplary decoder according to an embodiment of the present disclosure suitable for use with an encoder performing weighted predictions. The decoder is adapted to receive and decode a bitstream (202) to obtain an output image or reconstructed video (220). The decoder may comprise an entropy decoding unit (208), an inverse quantizing unit (210), an inverse transforming unit (212), a second adder unit (226), a spatial prediction unit (260), a motion prediction unit (262), a reference picture store or buffer (264), and a mode selection unit (280).

The entropy decoding unit (208) may be adapted to decode the bitstream (202) and obtain processed image data with mode information from the bitstream (202). The inverse quantizing unit (210) is connected with the entropy decoding unit (208), and may be configured to remove quantization performed by a quantizing unit (such as 106 of FIG. 1) and is configured to output non-quantized data. The inverse transforming unit (212) is connected with the inverse quantizing unit (210) and may be adapted to remove transformation performed by a transforming unit (such as 104 of FIG. 1) and process the non-quantized data to obtain transformed data.

The second adder unit (226) may be coupled to the inverse transforming unit (212) and the second adder unit (226) may be configured to add the transformed data to prediction pictures from the mode selection unit (280) to generate reconstructed pictures, and the reconstructed pictures may go through loop filter (266) and be stored as reference pictures in the reference picture store (264). The spatial prediction unit (260) is coupled to the second adder unit (266) and the spatial prediction unit (260) may be configured to generate spatial prediction pictures based on reconstructed pictures from the second adder unit (226).

The motion prediction unit (262) is connected with the reference picture store (264), where the motion prediction unit (262) is configured to generate motion prediction pictures based on reference pictures from the reference picture store (264). The mode selection unit (280) is connected with the second adder unit (226) and the mode selection unit (280) is configured to generate prediction pictures based on mode information from the bitstream (202), spatial prediction pictures, and motion prediction pictures. The output image or reconstructed video (220) is based on the reference pictures of the reference picture store (264).

1. Weighted Prediction Based on Motion Information

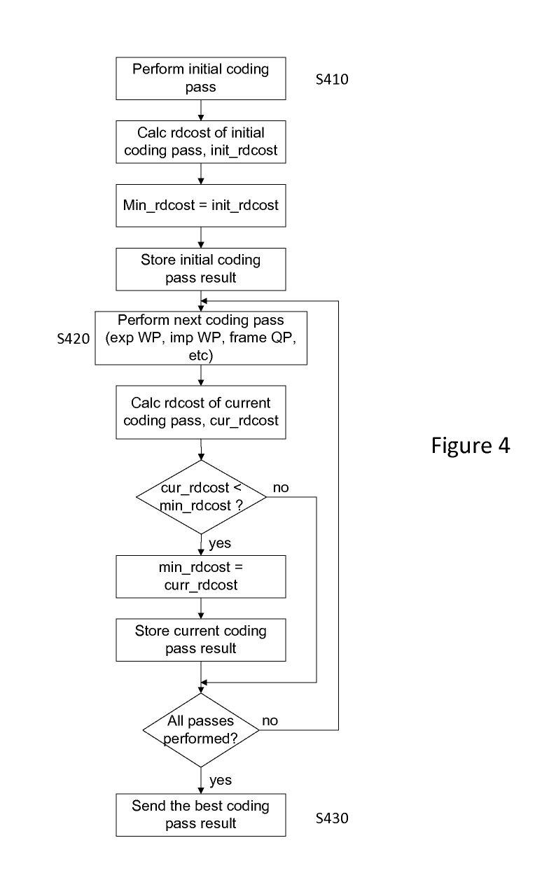

FIG. 4 shows an exemplary flow chart of a multiple-pass encoding method in accordance to an embodiment of the disclosure. The method can yield coding performance gain. However, such coding performance gain is generally associated with a cost of higher coding complexity [reference 3, incorporated herein by reference in its entirety]. In multi-pass encoding, the current picture may be coded more than once using different methods and settings. For example, the encoder may perform a first coding pass in a step S410 without weighted prediction, a second pass with explicit weighted prediction, a third pass with implicit weighted prediction, further passes with other, more refined WP parameters, and additional passes with different frame-level quantization parameters, and so forth. The second, third, and subsequent passes are shown in step S420. Afterwards, the encoder chooses as a final coding result the coding pass that yields the best coding performance, as judged by a set coding criterion in a step S430 (e.g., the rate-distortion Lagrangian cost [reference 4, incorporated herein by reference in its entirety]). Note that FIG. 4 shows use of rate-distortion cost as the coding criterion merely as an example. Many other criteria (e.g., criteria based on coding complexity, subjective quality, and so forth) may also be used.

In a multiple-pass encoding system, some information about the current picture can be obtained during the initial coding pass or passes. Such information includes block coding mode (intra vs. inter), block prediction mode (single-list prediction vs. bi-prediction, intra prediction mode, etc.), motion information (motion partitions, motion vectors, reference picture index, etc.), prediction residual, and so on. Such information can be used to derive the weighted prediction parameters more accurately, as explained below.

During the initial coding pass or passes, the blocks or groups of blocks that are coded using intra modes usually represent objects that failed to find closely matching blocks or groups of blocks from the reference pictures (for example, newly appearing objects in the current frame). Application of weighted prediction will generally have a lesser impact on the prediction accuracy of these intra-coded blocks or groups of blocks. As a result, such intra-coded blocks or groups of blocks can be excluded from the derivation process of the weighted prediction parameters.

For the inter-coded blocks or groups of blocks in the current frame, the derivation process may be expressed as follows. Denote a pixel at location (x, y) in the current picture as O(x, y). Assuming single-list prediction is used (the bi-prediction case will be detailed later in Section 4), the derivation of optimal weight wₒₚₜ and optimal offset oₒₚₜ can be expressed as follows:

$$\begin{matrix}( {w}_{opt} , {o}_{opt} ) = {arg min}_{w , o} {\sum }_{( x , y )} {( O ( x , y ) - WP ( x , y ) )}^{2} \\ = {arg min}_{w , o} {\sum }_{( x , y )} {( O ( x , y ) - ( w \cdot P ( x , y ) + o ) )}^{2}\end{matrix} \qquad ( 7 )$$

Therefore the optimal weighted prediction parameters (wₒₚₜ,oₒₚₜ) may be solved by the following:

$$\begin{matrix}( {P}^{T} \cdot P ) \cdot w = {P}^{T} \cdot O \\ where & ( 8 ) \\ w = ( \begin{matrix}{w}_{opt} \\ {o}_{opt}\end{matrix} ) & ( 9 ) \\ P = ( \begin{matrix}{P}_{{pix}_{0}} & 1 \\ ⋮ & \\ {P}_{{pix}_{M - 1}} & 1\end{matrix} ) & ( 10 ) \\ O = ( \begin{matrix}{Q}_{{pix}_{0}} \\ ⋮ \\ {O}_{{pix}_{M - 1}}\end{matrix} ) & ( 11 )\end{matrix}$$

where Oₚᵢₓ_{ⱼ} and Pₚᵢₓ_{ⱼ} are the values of the original pixel and the motion predicted pixel at location pixⱼ=(x, y)ⱼ, j=0 . . . M−1, respectively, where j denotes the j-th pixel and M denotes the total number of pixels in the current picture for inter prediction. It should be noted that (P^{T}·P) provides an auto-correlation matrix while P^{T}·O provides a cross-correlation vector.

The solution of equation (7) can be expressed as below, which gives the values of optimal weight and offset (wₒₚₜ,oₒₚₜ):

w=(P^{T}·P)⁻¹·P^{T}·O (12)

Some video coding systems, such as the H.264/AVC standard, allow use of multiple reference pictures, which means that blocks in the same picture/slice may choose different reference pictures for motion prediction, with reference picture indices of the selected reference pictures being signaled as part of a video bitstream (such as 202 of FIG. 2). For such systems, the weights and offsets may be derived separately for each reference picture using the process described above. Also, when the current picture/slice is a B coded picture/slice, the weights and offsets for each reference picture from each prediction list may be derived separately using the process described above.

2. Quantization of Weights and Offsets

The values of weight wₒₚₜ and offset oₒₚₜ as derived above have floating point precisions. They are generally quantized to fixed-point precision before being coded and packed into the video bitstream (such as 120 of FIG. 1). A simple and straightforward way to apply quantization is to quantize weight and offset separately to the nearest value with a set precision. For example, if N_{w} bits and Nₒ bits are used to represent the values of weight and offset, respectively, then the quantized values ŵₒₚₜ and ôₒₚₜ are:

ŵₒₚₜ=sign(wₒₚₜ)·floor(|wₒₚₜ|·2^{N}^{_{w}}+0.5)>>N_{w} (13)

ôₒₚₜ=sign(oₒₚₜ)·floor(|oₒₚₜ|·2^{N}^{ₒ}+0.5)>>N₀ (14)

Quantization introduces distortion to the optimal values (wₒₚₜ,oₒₚₜ); consequently, quantization can negatively impact quality of weighted prediction. Joint quantization of weight wₒₚₜ and offset oₒₚₜ can reduce errors due to quantization. The auto-correlation matrix (P^{T}·P) and the cross-correlation vector P^{T}·O in equation (8) can be rewritten into equations (15) and (16) shown below. The two linear equations may then be rewritten into equations (17a & b).

$$\begin{matrix}( {P}^{T} \cdot P ) = ( \begin{matrix}a & b \\ b & c\end{matrix} ) = ( \begin{matrix}{\sum }_{i = 0 …M - 1}^{ } {P}_{{pix}_{i}}^{2} & {\sum }_{i = 0 …M - 1} {P}_{{pix}_{i}} \\ {\sum }_{i = 0 …M - 1}^{ } {P}_{{pix}_{i}} & M\end{matrix} ) & ( 15 ) \\ ( {P}^{T} \cdot O ) = ( \begin{matrix}d \\ e\end{matrix} ) = ( \begin{matrix}{\sum }_{i = 0 …M - 1}^{ } {P}_{{pix}_{i} \cdot {O}_{{pix}_{i}}} \\ {\sum }_{i = 0 …M - 1}^{ } {O}_{{pix}_{i}}\end{matrix} ) & ( 16 ) \\ \{ \begin{matrix}a \cdot {w}_{opt} + b \cdot {o}_{opt} = d \\ b \cdot {w}_{opt} + c \cdot {o}_{opt} = e\end{matrix} & ( 17 a \& b )\end{matrix}$$

Then, joint quantization may be performed as shown in the following steps:
1. Solve equations (17a & b) to obtain wₒₚₜ first, and quantize wₒₚₜ to ŵₒₚₜ using equation (13);
2. Substitute ŵₒₚₜ in equation (17a) or equation (17b) to obtain oₒₚₜ, and quantize oₒₚₜ to ôₒₚₜ using equation (14).

Since first quantizing weight or first quantizing offset during joint quantization may produce different values of ŵₒₚₜ and ôₒₚₜ, a pair of best quantized values of ŵₒₚₜ and ôₒₚₜ may be decided by choosing ŵₒₚₜ and ôₒₚₜ such that the square error as shown in equation (18) is minimized

(d−(a·ŵₒₚₜ+b·ôₒₚₜ))²+(e−(b·ŵₒₚₜ+c·ôₒₚₜ))² (18)

In addition to rounding wₒₚₜ and oₒₚₜ to the nearest values with the set precision of N_{w} bits and Nₒ bits (as in equation (13) and equation (14)), the encoder may also apply floor( ) and ceiling( ) functions to (wₒₚₜ,oₒₚₜ) to obtain other candidate quantized values (ŵₒₚₜ,ôₒₚₜ). This way, the encoder can obtain a set of Q quantized candidates (ŵᵢ,ôᵢ), i=0 . . . Q−1, that are various numerical approximations of (wₒₚₜ,oₒₚₜ) with the set precision of N_{w} bits and Nₒ bits. The encoder may then choose the final quantized values (ŵ₁,ô₁), Iε{0 . . . Q−1}, to be those that minimize the error in equation (18).

3. Refinement of WP Parameters

Some video sequences contain severe illumination change. For example, a video sequence may be fading in from a completely dark picture. In such cases, the encoder may not be able to obtain sufficient and/or reliable motion information during the initial coding pass. The encoder may use any of the following methods (or any combination thereof) to detect insufficient and/or unreliable motion information:
1. Number of intra-coded blocks: if a large percentage of the blocks in the video picture/slice are coded as intra blocks, then the motion information obtained can be insufficient to reliably solve (wₒₚₜ,oₒₚₜ) using equation (12).
2. Prediction residual energy: if the prediction residual coming out of the first adder unit (116 in FIG. 1) has high energy, then the motion prediction is likely to be inaccurate, which in turn means the motion information obtained is likely unreliable.
3. Motion field regularity: the encoder can decide whether the obtained motion field is regular. If the motion field contains large amounts of irregular motion (e.g., motion that is scattered in different directions, has large magnitude variation, etc.), then the motion information may be considered unreliable. The decision on motion regularity may be made within one or more predefined regions or over the entire picture/slice.

The decision on sufficiency and/or reliability of the motion information may be made for the entire picture/slice, a region, a group of blocks, or a given block in the picture/slice. It is usually beneficial to exclude motion information deemed unreliable from the calculation of weights and offsets following equations (8)-(12).

Quantization can introduce distortion to the WP parameters derived from equations (8)-(12) and thus can reduce precision of the weighted prediction. The presence of unreliable and/or insufficient motion may introduce further problems. For this reason, the encoder can collect a set of Q WP parameter candidates (wᵢ,oᵢ), i=0 . . . Q−1, and choose the final weighting parameters to be used from the set based on a set criterion. For example, the set of WP parameter candidates can include the following:
1. The quantized weighting parameters (ŵₒₚₜ,ôₒₚₜ), e.g., using the joint quantization process in Section 2; and
2. Other values of weights and offsets derived using various image analysis methods (e.g., DC based weight-only and offset-only methods, LMS-based methods, histogram-based methods, and so on).

Assuming a Sum of Squared Error (SSE) is used as the criterion, the final weight and offset may be chosen by minimizing the following quantity in equation (19).

$$\begin{matrix}{arg min}_{( {w}_{i} , {o}_{i} )} {SSE}_{i} = {arg min}_{( {w}_{i} , {o}_{i} )} {\sum }_{( x , y )} {( O ( x , y ) - {WP}_{i} ( x , y ) )}^{2} \\ = {arg min}_{( {w}_{i} , {o}_{i} )} {\sum }_{( x , y )} {( O ( x , y ) - {w}_{i} \cdot P ( x , y ) - {o}_{i} )}^{2}\end{matrix} \qquad ( 19 )$$

Although the SSE is shown in equation (19), any other criteria, such as Sum of Absolute Difference (SAD), human visual system based quality measure, or other objective or subjective quality measures, may also be used to choose the final weight and offset.

Finally, if the amount of reliable motion information is deemed to be insufficient, then the weighting parameters (ŵₒₚₜ,ôₒₚₜ) (derived from equations (8)-(12) and quantized using equation (18)) are likely to be unreliable and therefore unsuitable to be used. In such a case, the encoder can exclude (ŵₒₚₜ,ôₒₚₜ) from the set of WP parameter candidates and instead only consider weights and offsets obtained from various image analysis methods, such as the DC based method, the LMS based method, histogram-based method, and so on.

In some video coding systems, such as H.264/AVC, reference picture re-ordering may be used to assign multiple reference picture indices to the same reference picture. When such is the case, each instance of reference picture index may be associated with its own WP parameters, which may be used to provide coding performance benefits if the current picture contains local (rather than global) illumination changes.

For example, the encoder may perform image analysis and/or segmentation to segment the current picture into one or more regions. Then, the process discussed above, including deciding whether the motion information is sufficient and/or reliable, deciding which of the motion information is reliable, and using the reliable motion information to calculate and select the best WP parameters, can be performed for each region separately. The different WP parameters for each region can then be sent to the decoder using reference picture re-ordering. Note that the term “region” here may refer to a collection of video blocks that are spatially consecutive or spatially disjoint.

4. Bi-Prediction WP Parameter Calculation

As mentioned earlier, bi-prediction is used in many video coding systems. When bi-prediction and weighted prediction are used together, two sets of weighting parameters, (w⁰,o⁰) and (w¹,o¹), one for each reference picture in each prediction list, are used. For example, the weighted bi-prediction in the form of equation (4) may be used. In a B-coded picture/slice, some blocks may be predicted using single-list prediction while others may be predicted using bi-prediction.

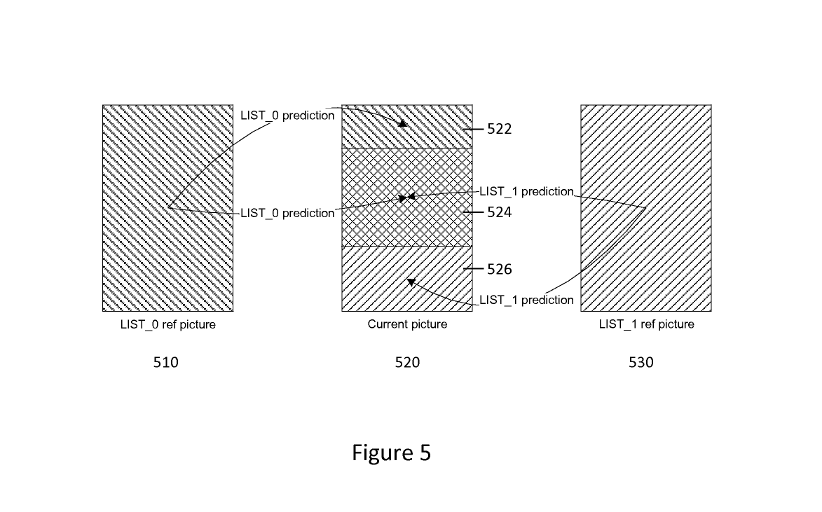

FIG. 5 shows an example where a top portion (522) of a current picture (520) is predicted using only reference picture (510) in prediction list LIST_{—}0, a bottom portion (526) is predicted using only reference picture (530) in prediction list LIST_{—}1, and a middle portion (524) is predicted using both reference pictures (510, 530). Some video coding systems, such as H.264/AVC, associate the same weighting parameters (w^{l},o^{l}) (l=0,1) with a given reference picture, regardless of whether the given reference picture is used in single-list prediction or bi-prediction. In other words, in the example shown in FIG. 5, the same weighting parameters (w⁰,o⁰) can be applied to a prediction obtained from the LIST_{—}0 reference picture (510) for both the top portion (522) and the middle portion (524) of the current picture (520). Therefore, the optimization problem in equation (7) can be rewritten as in equation (20), where the values of (wₒₚₜ⁰,oₒₚₜ⁰) and (wₒₚₜ¹,oₒₚₜ¹) are jointly derived.

$$\begin{matrix}( {w}_{opt}^{0} , {o}_{opt}^{0} , {w}_{opt}^{1} , {o}_{opt}^{1} ) = {arg min}_{( {w}^{0} , {o}^{0} , {w}^{1} , {o}^{1} )} {( {\sum }_{( x , y )} O ( x , y ) - WP ( x , y ) )}^{2} \\ = {arg min}_{( {w}^{0} , {o}^{0} , {w}^{1} , {o}^{1} )} {( {\sum }_{( x , y ) ∈ A} ( O ( x , y ) - {w}^{0} \cdot {P}^{0} ( x , y ) + {o}^{0} ) )}^{2} + \\ {\sum }_{( x , y ) ∈ B} {( O ( x , y ) - ( {w}^{1} \cdot {P}^{1} ( x , y ) + {o}^{1} ) )}^{2} + \\ {\sum }_{( x , y ) ∈ C} ( O ( x , y ) - ( ( {w}^{0} \cdot {P}^{0} ( x , y ) + {o}^{0} + {w}^{1} \cdot \\ { {P}^{1} ( x , y ) + {o}^{1} ) >> 1 ) )}^{2} )\end{matrix} \qquad ( 20 )$$

where A includes the group of pixels in the current picture/slice predicted using single-list prediction with LIST_{—}0 (e.g., top portion (522) of the current picture (520) in FIG. 5), B includes the group of pixels in the current picture/slice that are predicted using single-list prediction with LIST_{—}1 (e.g., bottom portion (526) of the current picture (520) in FIG. 5), and C includes the group of pixels in the current picture/slice that are predicted using bi-prediction with LIST_{—}0 and LIST_{—}1 (e.g., middle portion (524) of the current picture (520) in FIG. 5). Solution to the optimization problem in equation (20) can be written as the following:

$$\begin{matrix}( {P}^{T} \cdot P ) \cdot w = {P}^{T} \cdot O \\ where & ( 21 ) \\ w = ( \begin{matrix}{w}_{opt}^{0} \\ {w}_{opt}^{1} \\ {o}_{opt}^{0} \\ {o}_{opt}^{1}\end{matrix} ) & ( 22 ) \\ P = ( \begin{matrix}{P}_{{pix}_{0}^{A}}^{0} & 0 & 1 & 0 \\ ⋮ & & & ⋮ \\ {P}_{{pix}_{MA - 1}^{A}}^{0} & 0 & 1 & 0 \\ 0 & {P}_{{pix}_{0}^{B}}^{1} & 0 & 1 \\ ⋮ & & & ⋮ \\ 0 & {P}_{{pix}_{MB - 1}^{B}}^{1} & 0 & 1 \\ \frac{1}{2} {P}_{{pix}_{0}^{C}}^{0} & \frac{1}{2} {P}_{{pix}_{0}^{C}}^{1} & \frac{1}{2} & \frac{1}{2} \\ ⋮ & & & ⋮ \\ \frac{1}{2} {P}_{{pix}_{MC - 1}^{C}}^{0} & \frac{1}{2} {P}_{{pix}_{MC - 1}^{C}}^{1} & \frac{1}{2} & \frac{1}{2}\end{matrix} ) & ( 23 ) \\ O = ( \begin{matrix}{O}_{{pix}_{0}^{A}} \\ ⋮ \\ {O}_{{pix}_{MA - 1}^{A}} \\ {O}_{{pix}_{0}^{B}} \\ ⋮ \\ {O}_{{pix}_{MB - 1}^{B}} \\ {O}_{{pix}_{0}^{C}} \\ ⋮ \\ {O}_{{pix}_{MC \_ 1}^{C}}\end{matrix} ) & ( 24 )\end{matrix}$$

The auto-correlation matrix and cross-correlation vector in equation (21) can be further written as

$$\begin{matrix}( {P}^{T} \cdot P ) = ( \begin{matrix}{\sum }_{{pix}_{i} ∈ A} {P}_{{pix}_{i}}^{{0}^{2}} + \frac{1}{4} {\sum }_{{pix}_{i} ∈ c} {P}_{{pix}_{i}}^{{0}^{2}} & \frac{1}{4} {\sum }_{{pix}_{i} ∈ c} {P}_{{pix}_{i}}^{0} \cdot {P}_{{pix}_{i}}^{1} & {\sum }_{{pix}_{i} ∈ A} {P}_{{pix}_{i}}^{0} + \frac{1}{4} {\sum }_{{pix}_{i} ∈ c} {P}_{{pix}_{i}}^{0} & \frac{1}{4} {\sum }_{{pix}_{i} ∈ c} {P}_{{pix}_{i}}^{0} \\ \frac{1}{4} {\sum }_{{pix}_{i} ∈ c} {P}_{{pix}_{1}}^{0} \cdot {P}_{{pix}_{1}}^{1} & {\sum }_{{pix}_{i} ∈ B} {P}_{{pix}_{i}}^{{1}^{2}} + \frac{1}{4} {\sum }_{{pix}_{i} ∈ c} {P}_{{pix}_{i}}^{{1}^{2}} & \frac{1}{4 } {\sum }_{{pix}_{i} ∈ c} {P}_{{pix}_{i}}^{1} & {\sum }_{{pix}_{i} ∈ B} {P}_{{pix}_{i}}^{1} + \frac{1}{4} {\sum }_{{pix}_{i} ∈ c} {P}_{{pix}_{i}}^{1} \\ {\sum }_{{pix}_{i} ∈ A} {P}_{{pix}_{i}}^{0} + \frac{1}{4} {\sum }_{{pix}_{i} ∈ c} {P}_{{pix}_{i}}^{0} & \frac{1}{4} {\sum }_{{pix}_{i} ∈ c} {P}_{{pix}_{i}}^{1} & MA + \frac{1}{4} MC & \frac{1}{4} MC \\ \frac{1}{4} {\sum }_{{pix}_{i} ∈ c} {P}_{{pix}_{i}}^{{0}^{2}} & {\sum }_{{pix}_{i} ∈ B} {P}_{{pix}_{i}}^{1} + \frac{1}{4} {\sum }_{{pix}_{i} ∈ c} {P}_{{pix}_{i}}^{1} & \frac{1}{4} MC & MB + \frac{1}{4} MC\end{matrix} ) & ( 25 ) \\ ( {P}^{T} \cdot O ) = ( \begin{matrix}{\sum }_{{pix}_{i} ∈ A} {P}_{{pix}_{i}}^{0} \cdot {O}_{{pix}_{i}} + \frac{1}{2} {\sum }_{{pix}_{i} ∈ c} {P}_{{pix}_{i}}^{0} \cdot {O}_{{pix}_{i}} \\ {\sum }_{{pix}_{i} ∈ B} {P}_{{pix}_{i}}^{1} \cdot {O}_{{pix}_{i}} + \frac{1}{2} {\sum }_{{pix}_{i} ∈ c} {P}_{{pix}_{i}}^{1} \cdot {O}_{{pix}_{i}} \\ {\sum }_{{pix}_{i} ∈ B} \cdot {O}_{{pix}_{i}} + \frac{1}{2} {\sum }_{{pix}_{i} ∈ c} \cdot {O}_{{pix}_{i}} \\ {\sum }_{{pix}_{i} ∈ B} \cdot {O}_{{pix}_{i}} + \frac{1}{2} {\sum }_{{pix}_{i} ∈ c} \cdot {O}_{{pix}_{i}}\end{matrix} ) & ( 26 )\end{matrix}$$

where Oₚᵢₓ_{ᵢ}, Pₚᵢₓ_{ᵢ}⁰, and Pₚᵢₓ_{ᵢ}¹ are the original pixel, the motion predicted pixel from LIST_{—}0, and the motion predicted pixel from LIST_{—}1, at location pixᵢ=(x, y)ᵢ, respectively; and MA, MB, and MC are the number of pixels in the region A (LIST_{—}0 predicted region), region B (LIST_{—}1 predicted region), and region C (bi-predicted region), respectively. When both region A and region B are zero, that is, all of the inter-coded blocks in the current picture/slice are bi-predicted, the auto-correlation matrix (P^{T}·P) becomes irreversible. In this case, instead of solving for

$$w = ( \begin{matrix}{w}_{opt}^{0} \\ {w}_{opt}^{1} \\ {o}_{opt}^{0} \\ {o}_{opt}^{1}\end{matrix} )$$

as in (22), the encoder can instead solve for

$$w = ( \begin{matrix}{w}_{opt}^{0} \\ {w}_{opt}^{1} \\ {o}_{opt}^{0} + {o}_{opt}^{1}\end{matrix} ) .$$

The encoder can then use other means to determine o⁰ and o¹ separately based on the value of oₒₚₜ⁰+oₒₚₜ¹. For example, the encoder can calculate the value of o¹ using an image-analysis based method and calculate the value of o⁰=(oₒₚₜ⁰+oₒₚₜ¹)−o¹, or vice versa.

When multiple reference pictures are used, each prediction list may contain more than one reference picture. Therefore, in a B-coded picture/slice, blocks may be predicted not only using single-list prediction or bi-prediction but also using different reference pictures in each prediction list. In this case, the joint optimization process in equations (20) and (21) can be further extended to solve all of the following weighting parameters at once:

$$w = ( \begin{matrix}{w}_{opt}^{0 , 0} \\ ⋮ \\ {w}_{opt}^{{L}_{0} - 1 , 0} \\ {w}_{opt}^{0 , 1} \\ ⋮ \\ {w}_{opt}^{{L}_{1} - 1 , 1} \\ {o}_{opt}^{0 , 0} \\ ⋮ \\ {0}_{opt}^{{L}_{0} - 1 , 0} \\ {o}_{opt}^{0 , 1} \\ ⋮ \\ {o}_{opt}^{{L}_{1} - 1 , 1}\end{matrix} ) \qquad ( 27 )$$

where (wₒₚₜ^{i,1}, oₒₚₜ^{i,1}) are the weighting parameters associated with the i-th reference picture in prediction list LIST_l, l=0, 1, and L₀ and L₁ are the number of reference pictures in LIST_{—}0 and LIST_{—}1, respectively. Note that equation (27) can also be extended from the bi-prediction case (combination of two prediction signals from two prediction lists) to the multi-hypothesis prediction case (combination of three or more prediction signals from three or more prediction lists).

As the number of reference pictures in each prediction list increases, the dimension of the autocorrelation matrix (P^{T}·P), (2(L₀+L₁))×(2(L₀+L₁)), increases quickly as well, leading to higher complexity when solving for all the weighting parameters in equation (27) jointly. Further, it also becomes more likely that some reference pictures may start to have insufficient prediction samples and/or unreliable motion information. Consequently, the autocorrelation matrix (P^{T}·P) may become unstable and even irreversible.

One way to get around inverting unstable and large matrices is to apply the joint optimization process only on the most frequently used reference pictures. For example, one most frequently used reference picture can be identified in each prediction list, although two (or more) most frequently reference pictures in each prediction list can also be identified. These frequently used reference pictures can be identified based on the motion information obtained from the initial coding pass or passes. The encoder then follows equations (21)-(26) to obtain the weighting parameters for these most frequency used, which can referred to as “important,” reference pictures. For all the remaining less frequently used reference pictures, one of the following options may be used to obtain their weighting parameters:
1. The separate optimization process in equations (8)-(12) may be applied;
2. An image-analysis based algorithm may be used.

Note that considerations discussed in Sections 2 and 3, including better quantization of the weighting parameters, detection of insufficient/unreliable motion information, and selection of the final weighting parameters from a set of candidates based on a set criterion, and so on, are also applicable to the bi-prediction case discussed in this section for B-coded pictures/slices.

5. Iterative WP Parameter Estimation and Refinement

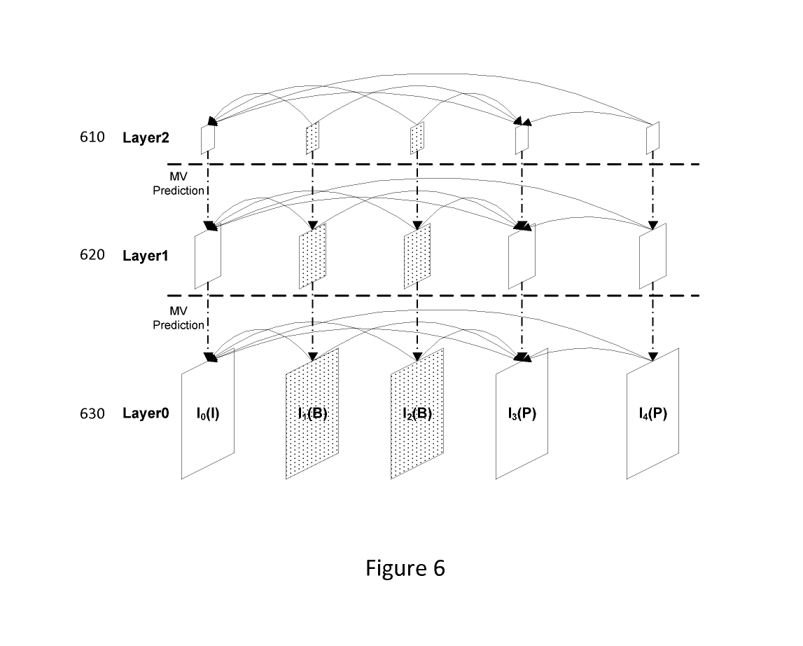

An efficient H.264/AVC encoder implementation may include a hierarchical motion estimation engine (or HME, as depicted in FIG. 6 and described in U.S. Provisional Patent Application with Ser. No. 61/550,280, for “Hierarchical Motion Estimation for Video Compression and Motion Analysis,” Applicants' Docket No. D11108USP1, filed on Oct. 21, 2011, the disclosure of which is incorporated by reference. The HME performs a layered motion search on various down-sampled versions of the input video picture, starting with a lowest resolution (610) (e.g., ¼ of the original resolution in each dimension) and progressing on with higher resolutions (620) (e.g., ½ of the original resolution in each dimension), until an original resolution (630) is reached.

As used in this disclosure, the term “hierarchical layer” or “h-layer” refers to a full set, a superset, or a subset of an input picture of video information for use in HME processes. Each h-layer may be at a resolution of the input picture (full resolution), at a resolution lower than the input picture, or at a resolution higher than the input picture. Each h-layer may have a resolution determined by the scaling factor associated to that h-layer, and the scaling factor of each h-layer can be different.

An h-layer can be of higher resolution than the input picture. For example, subpixel refinements may be used to create additional h-layers with higher resolution. The term “higher h-layer” is used interchangeably with the term “upper h-layer” and refers to an h-layer which is processed prior to processing of a current h-layer under consideration. Similarly, the term “lower h-layer” refers to an h-layer which is processed after the processing of the current h-layer under consideration. It is possible for a higher h-layer to be at the same resolution as that of a previous h-layer, such as in a case of multiple iterations, or at a different resolution.

It is noted that a higher h-layer may be at the same resolution, for example, when reusing an image at the same resolution with a certain filter or when using an image at the same resolution using a different filter. The HME process can be iteratively applied if necessary. For example, once the HME process is applied to all h-layers, starting from the highest h-layer down to the lowest h-layer, the process can be repeated by feeding the motion information from the lowest h-layer again back to the highest h-layer as the initial set of motion predictors. A new iteration of the HME process can then be applied.

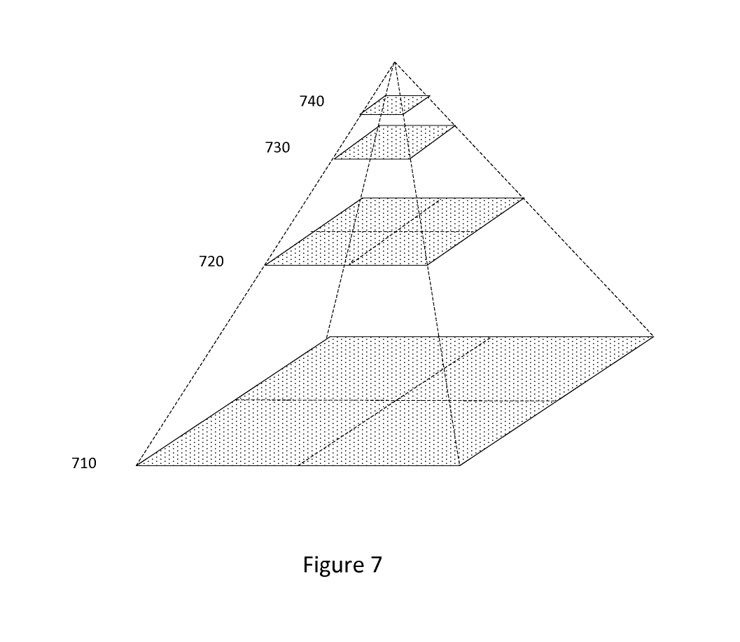

FIG. 7 provides another diagram showing an example of down-sampling hierarchical layers (h-layers) of an input video picture, where h-layer (710) shows an original resolution, h-layer (720) shows a down-sampling from the original resolution (e.g., ¼ of the original resolution), h-layer (730) shows a further down-sampling (e.g., ¼ of the resolution of h-layer (720)), and h-layer (740) shows still further down-sampling (e.g., ¼ of the resolution of h-layer (730)). The video picture is thus successively sampled down for HME. Because the down-sampling process may help remove or reduce noise in the original picture, compared to performing motion search directly on the original picture, HME's layered structure may return a more regularized motion field with more reliable motion information. The regularized motion field is not random and follows a certain order that is more similar to the true motion field in the world. Afterwards, such motion information from HME can be used to assist in the motion estimation and mode selection processes during the actual coding pass or passes.

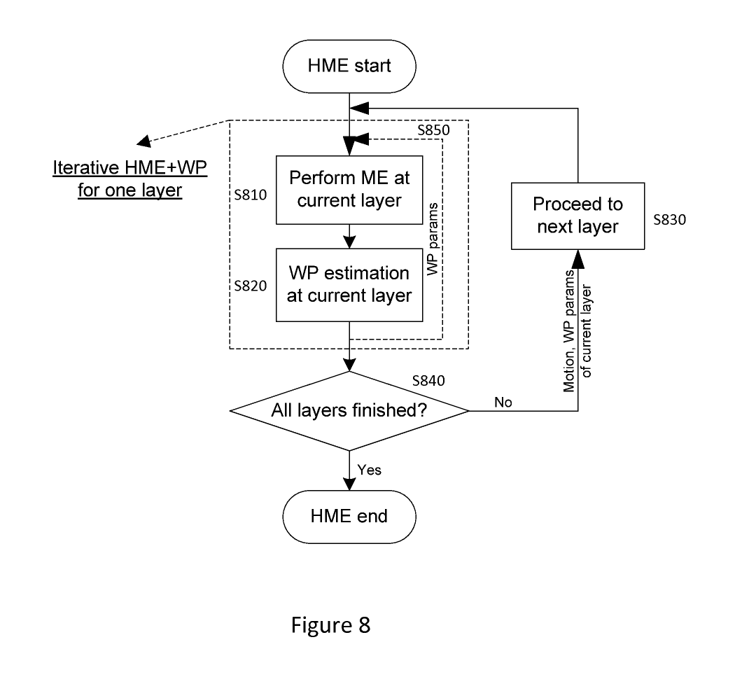

In relation to this disclosure, such motion information from HME may also be used to estimate the WP parameters using the methods described herein and as shown in FIG. 8. At each h-layer of the HME, using the motion information obtained with motion search during a step S810, WP parameters can be estimated in a step S820. Then, such motion information and WP parameters are used to improve the HME process at the next HME h-layer in a step S830. FIG. 8 shows the iterative process of repeating motion search and WP estimation across HME h-layers.

With the process in FIG. 8, both motion and WP parameters can become incrementally more accurate as the HME process proceeds, which can lead to better coding performance. Note that motion search and WP estimation can also be repeated multiple times for each given level in a step S850 (see dotted line labeled S850 in FIG. 8). While this additional iteration adds complexity, it may further improve the motion and WP parameter accuracy.

To restrain the additional complexity due to the iterative process, various termination schemes may be used in a step S840. For example, the iterative process may terminate when motion and WP parameters have converged and/or when a certain number of iterations have been performed. Also, for example, during iterations, only motion refinement (instead of motion search within a given search window) may be performed to further reduce complexity.

Alternatively or in conjunction, one may also select different block sizes for HME search at different h-layers and/or different resolutions during iterations to reduce complexity. For example, 8×8 block size may be selected for higher h-layers/lower resolutions and 16×16 block size may be selected for higher h-layers/higher resolutions.

As mentioned above, excluding intra-coded blocks from the WP estimation process may improve performance. Since HME does not perform full encoding that includes also the mode selection process, block mode information is usually not directly available after HME. To address this case, other HME information may be used in WP estimation.

For example, if a given block has high distortion (e.g., Sum of Squared Error or SSE, Sum of Absolute Difference or SAD, or another subjective quality based distortion), it may be excluded from the WP parameter estimation process. Alternatively, when calculating the auto-correlation (P^{T}·P) and the cross-correlation (P^{T}·O) as in equation (21), for each block, a weight inversely proportional to the block distortion can be applied. This way, blocks with lower distortion will have a bigger contribution toward (P^{T}·P) and (P^{T}·O), and thus ultimately a bigger influence on the WP parameters.

The iterative process of HME and WP estimation described herein is single-pass in nature. Hence, the encoding complexity is lower compared to iterative WP estimation and refinement using multi-pass encoding.

To further reduce complexity, all of the methods described herein can also be applied to a temporally down-sampled (that is, lower frame rate) video signal. For example, the more accurate and more complex WP estimation process may be applied for some pictures while simpler techniques may be applied for the remaining pictures. The more accurate weights may indicate a certain transition type and may thus be used to “predict” and to “refine” the weights for the in-between pictures. By analyzing weights in the temporal direction, the encoder can detect the type of transition and illumination change in the sequence and thus estimate the WP parameters more accurately.

Embodiments of the present disclosure discuss various methods to derive accurate weighting parameters for weighted prediction to improve coding performance. Some of the following aspects are noted in this disclosure:
1. Using motion information to accurately derive WP parameters, and using motion information to select the optimal parameters from a set of multiple WP parameters.
2. For WP parameters obtained based on motion, joint quantization of weights and offsets.
3. Refinement of weighting parameters based on the amount of available and reliable motion.
4. Performing joint optimization for bi-prediction WP parameters, and simplification of the bi-prediction joint optimization process based on reference picture usage.
5. Combining motion information based WP estimation with Hierarchical Motion Estimation.

The techniques of the embodiments of the present disclosure discussed herein expect some motion information to be available; and using multiple-pass encoding and obtaining motion through the HME process have been given as examples to show how such motion information may be obtained and utilized. However, it should be noted that there are many other ways to obtain motion information. For example, instead of using a full-complexity coding pass or the HME, a fast coding pass may be used initially. Specifically, any combinations of the following speed-up considerations may be used to obtain motion information:
1. Low-complexity motion estimation and compensation (for example, only integer-precision motion search is performed).
2. Only a limited subset of coding modes is enabled, and fast (i.e., low-complexity) mode selection is used.
3. Perform the initial coding pass using a spatially down-sampled video frame, and then upsample the mode and motion information accordingly.
4. Perform the initial coding pass on a temporally down-sampled video sequence, and derive missing motion for the pictures in between based on temporal distance.

The methods and systems described in the present disclosure may be implemented in hardware, software, firmware, or combination thereof. Features described as blocks, modules, or components may be implemented together (e.g., in a logic device such as an integrated logic device) or separately (e.g., as separate connected logic devices). The software portion of the methods of the present disclosure may comprise a computer-readable medium which comprises instructions that, when executed, perform, at least in part, the described methods. The computer-readable medium may comprise, for example, a random access memory (RAM) and/or a read-only memory (ROM). The instructions may be executed by a processor (e.g., a digital signal processor (DSP), an application specific integrated circuit (ASIC), or a field programmable logic array (FPGA)).

All patents and publications mentioned in the specification may be indicative of the levels of skill of those skilled in the art to which the disclosure pertains. All references cited in this disclosure are incorporated by reference to the same extent as if each reference had been incorporated by reference in its entirety individually.

The examples set forth above are provided to give those of ordinary skill in the art a complete disclosure and description of how to make and use the embodiments of the weighted predictions based on motion information of the disclosure, and are not intended to limit the scope of what the inventors regard as their disclosure. Modifications of the above-described modes for carrying out the disclosure may be used by persons of skill in the video art, and are intended to be within the scope of the following claims.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications may be made without departing from the spirit and scope of the present disclosure. Accordingly, other embodiments are within the scope of the following claims.

### REFERENCES

[reference 1] Advanced video coding for generic audiovisual services, November 2007 SMPTE 421M, “VC-1 Compressed Video Bitstream Format and Decoding Process,” April 2006.
[reference 2] JM reference software

JM16.1,http://iphome hhi.de/suehring/tml/download/, September, 2009, website accessed Oct. 20, 2011
[reference 3] A. M. Tourapis, K. Stihring, and G. J. Sullivan, “H.264/MPEG-4 AVC Reference Software Enhancements,” Joint Video Team (JVT) of ISO/IEC MPEG & ITU-T VCEG (ISO/IEC JTC1/SC29/WG11 and ITU-T SG16 Q.6) document no. N014, Hong Kong, January 2005.
[reference 4] G. J. Sullivan and T. Wiegand, “Rate-distortion optimization for video compression,” IEEE Signal Processing Magazine, vol. 15, issue 6, November 1998.
[reference 5] H. Kato and Y. Nakajima, “Weighting factor determination algorithm for H.264/MPEG-4 AVC weighted prediction,” Proc. IEEE 6th Workshop on Multimedia Signal Proc., Siena, Italy, October 2004.
[reference 6] Y. Kikuchi and T. Chujoh, “Interpolation coefficient adaptation in multi-frame interpolative prediction,” Joint Video Team (JVT) of ISO/IEC MPEG & ITU-T VCEG (ISO/IEC JTC1/SC29/WG11 and ITU-T SG16 Q.6) document no. C103, Fairfax, Va., March 2002.
[reference 7] K. Kamikura, H. Watanabe, H. Jozawa, H. Kotera, and S. Ichinose, “Global brightness-variation compensation for video coding,” Circuits and Systems for Video Technology, IEEE Transactions on, vol. 8, no. 8, pp. 988-1000, December 1998.
[reference 8] P. Yin, A. Tourapis, and J. Boyce, “Method and apparatus for adaptive weight selection for motion compensated prediction,” US patent application publication no. US 2009/0010330.
[reference 9] J. Boyce and A. Stein, “Motion estimation with weighting prediction,” U.S. Pat. No. 7,376,186.
[reference 10] Flierl, Wiegand, and Girod, “A Locally Optimal Design Algorithm for Block-Based Multi-Hypothesis Motion-Compensated Prediction,” in Proceedings of the IEEE DCC, pp. 239-248, Snowbird, Utah, March 1998.

1-45. (canceled)

46. A method for generating prediction pictures adapted for use in performing compression of video signals, comprising:
a) providing an input video signal, the input video signal comprising input blocks, slices, layers or pictures;
segmenting the input video signal into a plurality of regions, with each of the plurality of regions exhibiting a common characteristic; separately for each of the plurality of regions:
b) performing a first coding pass, the first coding pass comprising a first motion estimation, wherein the first motion estimation is based on one or more reference pictures and the input blocks, slices, layers or pictures in the input video signal;
c) deriving a first set of weighted prediction parameters based on results of the first coding pass;
d) calculating a second motion estimation based on results of the first motion estimation and the first set of weighted prediction parameters;
e) producing a second set of weighted prediction parameters based on the first set of weighted prediction parameters and results of the second motion estimation;
f) evaluating a convergence criterion to see if a set value is reached; and
g) iterating steps d) through f) to produce a third and subsequent motion estimations and a third and subsequent sets of weighted prediction parameters if the set convergence criterion has not been reached, until the set convergence criterion is reached or a set number of iterations are performed, thus generating prediction pictures for the performing compression of video signals.

47. The method according to claim 46, wherein the performing of the first coding pass of step b) further comprises calculating and producing a preliminary set of weighted prediction parameters by utilizing image analysis, and wherein the first motion estimation is further based on the preliminary set of weighted parameters.

48. The method according to claim 46, wherein the first set of weighted prediction parameters comprises explicit weighted predictions and the second set of weighted prediction parameters comprises implicit weighted predictions.

49. The method according to claim 46, wherein the first coding pass further comprises collecting one or more information sets, each information set selected from the group consisting of block coding mode, block prediction mode, motion information, and prediction residual.

50. The method according to claim 46, wherein each input region, slice, layer or picture is segmented into a plurality of blocks, and wherein the deriving and producing of weighted prediction parameters exclude one or more blocks or groups of blocks coded using intra modes.

51. The method according to claim 46, wherein the calculating and producing or applying is further based on reference pictures from one or more lists of reference pictures.

52. The method according to claim 46, wherein the calculating and producing for each block in an input region, slice, layer or picture is further based on a reference picture.

53. The method according to claim 46, wherein the second and subsequent sets of weighted prediction parameters associated with each reference picture are distinct.

54. The method according to claim 46, wherein the method is further adapted to utilize reference picture re-ordering to assign more than one reference picture index to each reference picture.

55. The method according to claim 46, wherein the second and subsequent sets of weighted prediction parameters are distinct for each instance of reference picture index.

56. The method according to claim 46, wherein the deriving and producing of weighted prediction parameters further comprises joint quantization of weight and offset to fixed-point values.

57. The method according to claim 46, wherein each of the deriving and producing of weighted prediction parameters comprises selecting joint quantized parameters or selecting an image-analysis based parameter based on one or more algorithms selected from the group consisting of a DC based weight method, an offset only method, an LMS-based method, and a histogram based method.

58. The method according to claim 46, wherein the set convergence criterion is selected from the group consisting of a sum square error, a sum of absolute difference, and a human visual system based quality measure.

59. The method according to claim 46, wherein the calculating of a second, third or subsequent motion estimation is adapted to detect insufficient and/or unreliable motion information by utilizing one or more methods selected from the group consisting of number of intra-coded blocks, prediction residual energy, and motion field regularity.

60. The method according to claim 59, wherein the motion estimation is detected to be insufficient and/or unreliable based on a percentage of intra-coded blocks in the input video signal.

61. The method according to claim 59, wherein the motion estimation is detected to be insufficient and/or unreliable based on the level of prediction residual energy output from a first adder unit.

62. The method according to claim 59, wherein the motion estimation is detected to be insufficient and/or unreliable based on amount of irregular motion in a motion field associated with the input video signal.

63. The method according to claim 59, further comprising excluding the insufficient and/or unreliable motion information from the producing of the second, third or subsequent sets of weighted prediction parameters.

64. The method according to claim 51, wherein the calculating and producing or applying for each block of a region, slice, layer or picture is based on more than one reference picture.

65. The method according to claim 64, wherein one set of weighted prediction parameters is associated with one or more reference pictures for both single-list prediction and bi-list prediction.
